(19) United States
(12) Patent Application Publication
(10) Pub. No.: US 2026/0246212 A1
(43) Pub. Date: Aug. 20, 2026

(54) POWER CONNECTOR ASSEMBLY FOR AN ELECTRIC DRIVE UNIT

(71) Applicant: American Axle & Manufacturing, Inc., Detroit, MI (US)

(72) Inventor: Salvatore N. GRUPIDO, Rochester, MI (US)

(21) Appl. No.: 19/164,922

(22) PCT Filed: Mar. 14, 2024
(86) PCT No.: PCT/US2024/019836

§ 371 Date: Sep. 12, 2025

Related U.S. Application Data
(60) Provisional application No. 63/490,020, filed on Mar. 14, 2023.

(51) Int. Cl. H01R 13/74; H01R 13/502; H01R 13/639; H01R 24/66; H01R 103/00

(52) U.S. Cl. CPC H01R 13/748; H01R 13/502; H01R 13/6397; H01R 24/66; H01R 2103/00; H01R 2201/26

(57) ABSTRACT

A power connector assembly having first and second connector assemblies with mating housing members. The housing member of the first connector assembly includes a mounting flange having one or more apertures that are configured to receive threaded fasteners therethrough for securing the first connector assembly to another structure. The housing member of the second connector assembly has one or more shroud members that extend from the housing member and cover or shroud the apertures in the housing member of the first connector assembly to correspondingly limit access to the fasteners so that the fasteners cannot be removed while the first and second connector assemblies are connected to one another.

### FIELD

The present disclosure relates to a power connector assembly for an electric drive unit.

### BACKGROUND

Electric drive units typically include a battery, an inverter, and a rotating electrical machine and are used to at least partially propel a vehicle. The electric drive units may use a power connector assembly to detachably connect the battery with other portions of the electric drive units.

### SUMMARY

This section provides a general summary of the disclosure, and is not a comprehensive disclosure of its full scope or all of its features.

In one form, the present disclosure provides a power connector assembly having a first connector assembly and a second connector assembly. The first connector assembly has a first housing and a plurality of first terminals. The first housing includes a first housing member and a mounting flange that is disposed about the first housing member. The mounting flange defines a plurality of fastener apertures. The first terminals are housed in the first housing. The second connector assembly has a second housing and a plurality of second terminals. The second housing includes a second housing member and one or more shroud members. The second housing member matingly engages the first housing member. The one or more shroud members extend outwardly from the second housing member and shroud the fastener apertures. The second terminals are housed in the second housing member. Each of the second terminals is mechanically and electrically engaged to a corresponding one of the first terminals.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a power connector assembly constructed in accordance with the teachings of the present disclosure in an environment that includes a battery and an electric drive unit;

FIG. 2 is a perspective view of the power connector assembly of FIG. 1 as mounted to a housing of the electric drive unit; and

FIG. 3 is a section view taken along the line 3-3 of FIG. 2.

Corresponding reference numerals indicate corresponding parts throughout the several views of the drawings.

### DETAILED DESCRIPTION

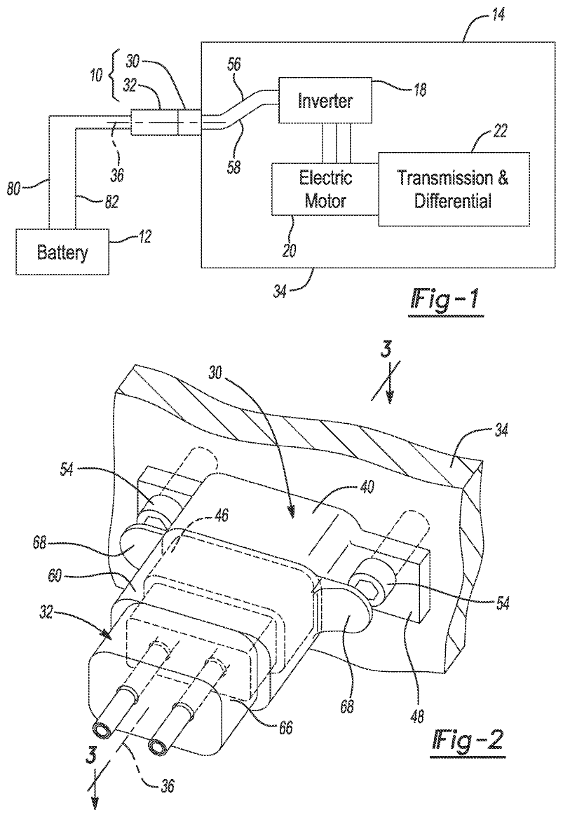

With reference to FIG. 1 of the drawings, a power connector assembly constructed in accordance with the teachings of the present disclosure is schematically illustrated and is generally indicated by reference numeral 10. The power connector assembly 10 is illustrated in operative association with a battery 12 and an electric drive unit 14. The electric drive unit 14 includes an inverter 18, an electric motor 20, a transmission and differential 22. Electric power input to the inverter 18 is employed to operate the electric motor 20. Rotary power output from the electric motor 20 is transmitted through the transmission (of the transmission and differential 22) to drive the differential (of the transmission and differential 22). The power connector assembly 10 is configured to quickly, efficiently and safely couple the battery 12 to the inverter 18. The power connector assembly 10 includes a first connector assembly 30 and a second connector assembly 32. The first connector assembly 30 is configured to be mounted to a housing 34 in which the inverter 18 is disposed and is electrically coupled to the inverter 18. The second connector assembly 32 is electrically coupled to the battery 12 and is matingly engagable to the first connector assembly 30 along an insertion axis 36 to both mechanically and electrically couple the second connector assembly 32 to the first connector assembly 30.

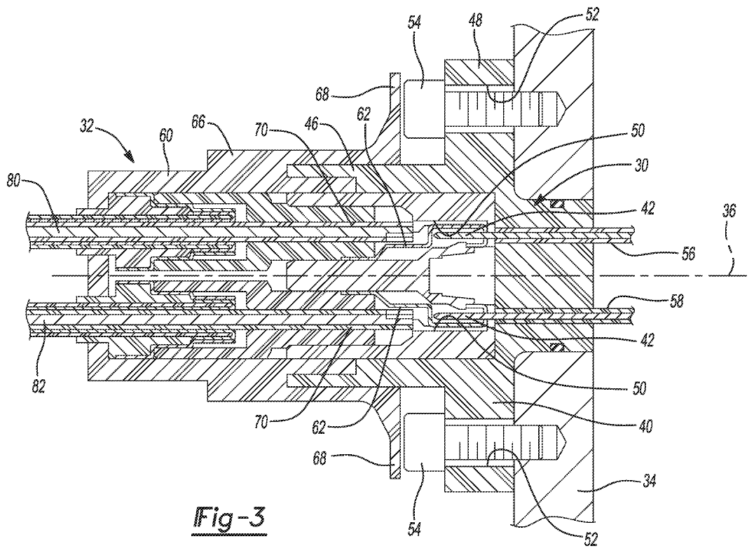

With reference to FIGS. 2 and 3, the first connector assembly 30 can include a first housing 40 and a plurality of first terminals 42. The first housing 40 has a first housing member 46 and a mounting flange 48 that is disposed about or extends from the first housing member 46. The first housing member 46 defines a plurality of first terminal cavities 50 that are disposed parallel to the insertion axis 36. The mounting flange 48 can defining a plurality of fastener apertures 52 that are configured to receive threaded fasteners 54 therethrough that secure the first housing 40 to the housing 34 of the electric drive unit 14 (FIG. 1). Each of the first terminals 42 is received in a corresponding one of the first terminal cavities 50 and is mechanically coupled to the first housing member 46. The first terminals 42 can be electrically coupled to a positive lead 56 and a ground lead 58 that are in turn electrically coupled to the inverter 18 (FIG. 1).

The second connector assembly 32 can have a second housing 60 and a plurality of second terminals 62. The second housing 60 can have a second housing member 66 and one or more shroud members 68. The second housing member 66 is configured to be slideably engagable to the first housing member 46 along the insertion axis 36 to permit the second housing member 66 to matingly engage the first housing member 46. The second housing member 66 can define a plurality of second terminal cavities 70 that are disposed parallel to the insertion axis 36. The one or more shroud members 68 can extend outwardly from the second housing member 66 into a location where it/they shroud the fastener apertures 52. More specifically, the one or more shroud members 68 extend outwardly from the first housing member 46 into a location where they substantially cover each of the threaded fasteners 54 that secure the first housing 40 to the housing 34 in which the inverter 18 (FIG. 1) is disposed. The one or more shroud members 68 can be spaced apart along the insertion axis 36 from the threaded fasteners 54 but are sufficiently close to prevent a tool (not shown) from being engaged to the threaded fasteners 54 so that the threaded fasteners 54 cannot be removed from the housing 34 while the second connector assembly 32 is engaged to the first connector assembly 30. In the particular example provided, the threaded fasteners 54 are socket head cap screws and as such, a tool for removing the threaded fasteners 54 (e.g., an Allen wrench) would be inserted into the axial end of the head of each of the threaded fasteners 54. As such, it is sufficient in this particular example that the one or more shroud members 68 extend over the axial end of the head of each of the threaded fasteners 54 to thereby inhibit insertion of a tool into the axial end of the head of the threaded fasteners 54. It will be appreciated that the configuration of the one or more shroud members 68 could be different from that which is depicted in this example if the threaded fasteners 54 were configured differently. For example, if the fasteners were hex headed bolts that could be engaged by a tool such as an open ended wrench, the one or more shroud members 68 could extend not only over the axial ends of the heads of the threaded fasteners 54, but also around the sides of the heads of the threaded fasteners 54 to prevent engagement of a tool to the sides of the heads of the threaded fasteners 54.

Each of the second terminals 62 is received in a corresponding one of the second terminal cavities 70 and is fixedly coupled to the second housing member 66. Each of the second terminals 62 can be mounted to a respective one of the positive and ground battery leads 80 and 82, respectively, that is electrically coupled to an associated one of the terminals of the battery 12. Each of the second terminals 62 is mechanically and electrically engagable to a corresponding one of the first terminals 42 to thereby electrically couple the terminals of the battery 12 (FIG. 1) to an associated one of the positive and ground leads 56 and 58.

It will be appreciated that any desired type of lock or latch mechanism can be employed to secure the second connector assembly 32 to the first connector assembly 30, and optionally to aid in seating the second connector assembly 32 to the first connector assembly 30. Due to the physical size of the conductors that are used for the positive and negative battery leads 80 and 82 and the positive and ground leads 56 and 58, a conventional and well known cam lever mechanism (not shown) could be employed to both seat and lock the second connector assembly 32 to the first connector assembly 30.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A power connector assembly comprising:
a first connector assembly having a first housing and a plurality of first terminals, the first housing having a first housing member and a mounting flange that is disposed about the first housing member, the mounting flange defining a plurality of fastener apertures, the first terminals being housed in the first housing; and
a second connector assembly having a second housing and a plurality of second terminals, the second housing having a second housing member and one or more shroud members, the second housing member matingly engaging the first housing member, the one or more shroud members extending outwardly from the second housing member and shrouding the fastener apertures, the second terminals being housed in the second housing member, each of the second terminals being mechanically and electrically engaged to a corresponding one of the first terminals.

2. The power connector assembly recited in claim 1, wherein the first connector assembly is configured to be mounted to a housing of an electric drive unit including an inverter.

3. The power connector assembly recited in claim 1, further comprising threaded fasteners passing through the fastener apertures, each threaded fastener having a head.

4. The power connector assembly recited in claim 3, wherein the one or more shroud members have a diameter that is larger than a diameter of the head.

5. The power connector assembly recited in claim 3, wherein the threaded fasteners are socket hex cap screws.

6. The power connector assembly recited in claim 1, wherein the second connector assembly is configured to electrically couple to a battery.

7. The power connector assembly recited in claim 1, wherein the second housing member matingly engages the first housing member along an insertion axis.

8. A power connector assembly comprising:
a first connector assembly having a first housing and a plurality of first terminals, the first housing having a first housing member and a mounting flange that is disposed about the first housing member, the mounting flange defining at least one fastener aperture configured to receive a threaded fastener, the first terminals being housed in the first housing; and
a second connector assembly having a second housing and a plurality of second terminals, the second housing having a second housing member and one or more shroud members, the second housing member matingly engaging the first housing member, the one or more shroud members extending outwardly from the second housing member and shrouding the at least one fastener aperture, the second terminals being housed in the second housing member, each of the second terminals being mechanically and electrically engaged to a corresponding one of the first terminals, wherein the one or more shroud members are configured to be sufficiently close to the threaded fastener to prevent a tool from engaging the threaded fastener and removing the threaded fastener while the second connector assembly is engaged to the first connector assembly.

9. The power connector assembly recited in claim 8, wherein the first connector assembly is configured to be mounted to a housing of an electric drive unit including an inverter.

10. The power connector assembly recited in claim 8, further comprising threaded fasteners passing through the fastener apertures, each threaded fastener having a head.

11. The power connector assembly recited in claim 10, wherein the one or more shroud members have a diameter that is larger than a diameter of the head.

12. The power connector assembly recited in claim 8, wherein the second connector assembly is configured to electrically couple to a battery.

13. The power connector assembly recited in claim 1, wherein the second housing member matingly engages the first housing member along an insertion axis.

14. A power connector assembly comprising:
a first connector assembly, including a plurality of first terminals configured to electrically couple to an inverter, and a mounting flange, the mounting flange defining a plurality of fastener apertures; and
a second connector assembly, including a plurality of second terminals configured to electrically couple to a battery, the second connector assembly having one or more shroud members, the second connector assembly matingly engaging the first connector assembly, and the one or more shroud members shrouding the fastener apertures while each of the second terminals is electrically engaged to a corresponding one of the first terminals.

15. The power connector assembly recited in claim 14, wherein the first connector assembly is configured to be mounted to a housing of an electric drive unit including the inverter.
